(19) United States
(12) Patent Application Publication
(10) Pub. No.: US 2013/0028247 A1
(43) Pub. Date: Jan. 31, 2013

(54) Method for Transmitting a Packet via Heterogeneous Networks

(71) Applicant: Yuan-Hwa Li, Hsinchu County (TW)

(72) Inventor: Yuan-Hwa Li, Hsinchu County (TW)

(21) Appl. No.: 13/314,199

(22) Filed: Dec. 8, 2011

(30) Foreign Application Priority Data
Jul. 29, 2011 (TW) 100126983

(51) Int. Cl. H04W 40/00; H04L 12/56

(52) U.S. Cl. 370/338; 370/401

(57) ABSTRACT

A method of transmitting a packet via heterogeneous networks, for a transmitter and a receiver using the heterogeneous networks comprising a first network and a second network is disclosed. The method comprises the transmitter transmitting the packet to the receiver via the first network and the second network, to improve robustness of the transmission of the packet; and the transmitter stopping transmitting the packet via the second network after the packet is transmitted successfully via the first network, or stopping transmitting the packet via the first network after the packet is transmitted successfully via the second network; wherein the first network and the second network are of different types or with different characteristics.

### BACKGROUND OF THE INVENTION

1. Field of the Invention

The present invention relates to a method of transmitting a packet, and more particularly, to a method of transmitting a packet via heterogeneous networks.

2. Description of the Prior Art

Heterogeneous networks, such as a combination of a wireless local area network (WLAN) and a power line communication (PLC) network, are usually deployed in the small area (e.g. home or office). The user can use one single device (e.g. computer or mobile device) to perform various kinds of data transmissions via the heterogeneous networks at the same time in this area.

For example, the user can watch a video on the Internet via the PLC network and at the same time listen to music on the Internet via the WLAN. But, when the user watches video without using the WLAN, the user cannot continue to watch the video if the PLC network is broken. Thus, capacity of the WLAN is not exploited and is wasted. Besides, the heterogeneous networks may be interfered by various interferences. For example, the WLAN may be interfered by another WLAN, a microwave oven or people walking; the PLC network may be interfered by a hair dryer or switching of a power switch. No matter what networks are used, quality of service (QoS) provided by the networks can not be guaranteed if only one network is used for a service at one time.

To solve the abovementioned problem, many methods of integrating the heterogeneous networks were proposed, such as the fixed allocation, dynamic allocation and repeated transmission solutions. When using these solutions, a sequence of packets of the same stream should be maintained while a sequence of packets of different streams can be arbitrary. Therefore, how to allocate and reorder the packets correctly is another problem needed to be solved.

The fixed allocation allocates a first network or a second network to a stream, for transmitting the stream via the first network or the second network, respectively. A packet of the stream is then transmitted via the first network or the second network. A method of choosing one of the first network and the second network for the stream is not limited. For example, the one of the first network and the second network for the stream can be chosen according to a destination of the stream, amount of packets of the stream or importance of the stream. If link quality of the first network is better than that of the second network and the importance of the stream is high, the stream can be transmitted via the first network. Oppositely, if the importance of the stream is low, the stream can be transmitted via the second network. Since the fixed allocation allocates only one network to the stream, the packets of the stream are transmitted and received in order, and do not need to be reordered. Therefore, the fixed allocation can be easily realized. However, capacity of the networks are not fully exploited and better QoS can not be obtained by using the fixed allocation, since only one network is allocated to the stream at one time.

For example, if the user wants to dial a VoIP (Voice over IP) and to send and receive emails, the user can dial the VoIP via the WLAN and send and receive the emails via the PLC network. In other words, packets related to the VoIP are transmitted and received via the WLAN, and packets related to the emails are transmitted and received via the PLC network. If the VoIP is interrupted due to a connection failure of the WLAN, the PLC network can not be allocated to the VoIP immediately, and the user needs to redial the VoIP via the PLC network.

On the other hand, the dynamic allocation allocates a first network, a second network or both the first network and the second network to a stream. When the dynamic allocation is realized, packets of the stream are transmitted dynamically via the first network and the second network. More specifically, conditions of the first network and the second network are detected, and the dynamic allocation is performed according to the conditions. For example, when the first network is in congestion or link quality of the first network is worse than link quality of the second network (e.g. a connection failure is only detected in the first network), the second network is chosen for transmitting the packets of the stream. Oppositely, when the second network is in congestion or the link quality of the second network is worse than the link quality of the first network, the first network is chosen for transmitting the packets of the stream. Therefore, when a packet is scheduled to be transmitted, the packet can be transmitted dynamically via the first network or the second network according to the link qualities of the first network and the second network. When the dynamic allocation is enabled, the transmitter needs to label the packet with a number, and the receiver needs to reorder the packet according to the number of the packet. Therefore, more computation and memory are required at the transmitter and the receiver. Benefits brought from costs of the computation and the memory are that flexibility for transmitting the stream is increased, and a packet error rate of the stream is reduced. However, the link quality is usually detected after packets are failed to be received at the receiver. That is, packet loss caused by the link quality is not completely solved. Besides, interference caused by environment and other devices is not mitigated. Therefore, the dynamic allocation is suitable for transmitting data, and is not suitable for transmitting multimedia.

For example, the user surfs the Internet via the WLAN and the PLC network, and watches a video on the Internet via the WLAN. That is, packets of the video are transmitted and received via the WLAN. When a connection failure is detected in the WLAN, the PLC network is allocated to the video, and the packets of the video are transmitted and received via the PLC network instead. Therefore, the user can continue to watch the video, after a short interrupt is caused to the video by the dynamic allocation.

Besides, the repeated transmission allocates a first network and a second network to a stream, for transmitting the stream via both the first network and the second network. Therefore, when one of the first network and the second network encounters a connection failure, a packet of the stream can still be transmitted successfully. When the repeated transmission is realized, a duplicate packet should be dropped and the received packet should be reordered. In other words, the transmitter needs to label the packet with a number, and the receiver needs to reorder the packet according to the number of the packet. Therefore, more computation and memory are required at the transmitter and the receiver. Besides, twice of the bandwidth is occupied since the packet is transmitted via both the first network and the second network at the same time. However, packet error rate is reduced and effect of interference is mitigated such that QoS provided by the networks is improved. The repeated allocation is suitable for transmitting multimedia, and is not suitable for transmitting data due to its low bandwidth efficiency, i.e., high cost.

For example, the user surfs the Internet via the WLAN and the PLC network, and watches a video on the Internet via both the WLAN and the PLC network. That is, packets of the video are transmitted and received via both the WLAN and the PLC network. When a connection failure is detected in the WLAN while the PLC network operates regularly, the packets of the video are still transmitted and received via the PLC network. Therefore, the user can continue to watch the video without any interrupt. On the other hand, the WLAN and the PLC network may be interfered by home appliances such that a packet error rate of 1% is caused to each of the WLAN and the PLC network. In this situation, the packet error rate that a packet is failed to be transmitted via both the WLAN and the PLC network is reduced to 0.01%

As can be seen from the above, heterogeneous networks are not integrated according to performance and characteristics of the heterogeneous networks, and inconvenience is caused to the user. Besides, integration provided by the prior art does not take transmission efficiency and QoS into account at the same time. That is, either the transmission efficiency or the QoS must be sacrificed for improving the other.

### SUMMARY OF THE INVENTION

The present invention therefore provides a method for transmitting a packet via heterogeneous networks to solve the abovementioned problems.

A method of transmitting a packet via heterogeneous networks, for a transmitter and a receiver using the heterogeneous networks comprising a first network and a second network is disclosed. The method comprises the transmitter transmitting the packet to the receiver via the first network and the second network, to improve robustness of the transmission of the packet; and the transmitter stopping transmitting the packet via the second network after the packet is transmitted successfully via the first network, or stopping transmitting the packet via the first network after the packet is transmitted successfully via the second network; wherein the first network and the second network are of different types or with different characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of an exemplary process according to the present invention.

FIG. 2 is a schematic diagram of exemplary heterogeneous networks according to the present invention.

### DETAILED DESCRIPTION

The present invention provides a method of transmitting a packet via heterogeneous networks, to utilize the heterogeneous networks efficiently and to improve robustness and transmission rate of the packet.

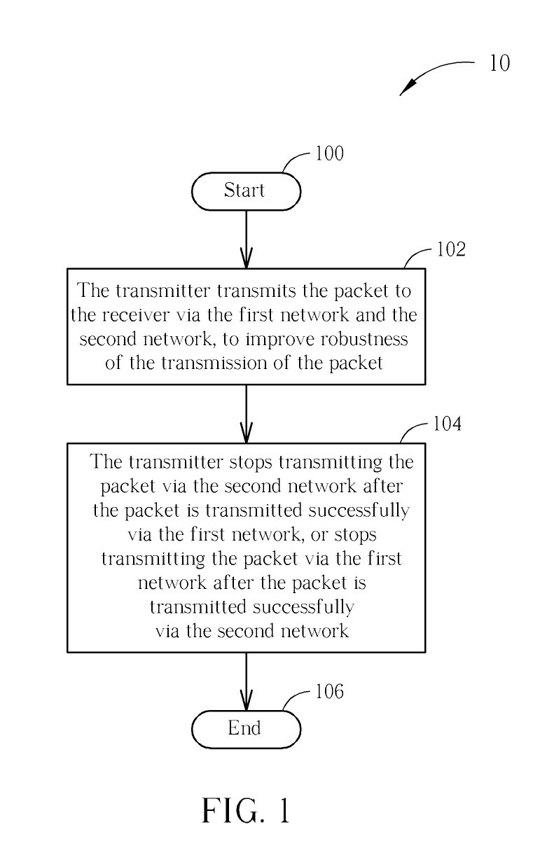

Please refer to FIG. 1, which is a flowchart of a process 10 according to an example of the present invention. The process 10 is used in a transmitter and a receiver, for transmitting and receiving a packet via both a first network and a second network. The process 10 includes the following steps:

Step 100: Start.

Step 102: The transmitter transmits the packet to the receiver via the first network and the second network, to improve robustness of the transmission of the packet.

Step 104: The transmitter stops transmitting the packet via the second network after the packet is transmitted successfully via the first network, or stops transmitting the packet via the first network after the packet is transmitted successfully via the second network.

Step 106: End.

According to the process 10, the transmitter transmits the packet to the receiver via the first network and the second network, to improve the robustness of the transmission of the packet. More specifically, the packet is considered being transmitted successfully as long as the packet is received correctly by the receiver via the first network or the second network. A probability that the packet is transmitted successfully is greatly increased by transmitting the packet via both the first network and the second network. Besides, the transmitter can stop transmitting the same packet via the first network or the second network, after the packet is transmitted successfully. In other words, the transmitter stops transmitting the same packet via the second network after the packet is transmitted successfully via the first network, or stops transmitting the same packet via the first network after the packet is transmitted successfully via the second network. Therefore, the present invention increase the probability that the packet is transmitted successfully, while a bandwidth required by the present invention is much lower than that required by the prior art.

For example, a user surfs the Internet via a wireless local area network (WLAN) and a power line communication (PLC) network. The user may watch a video on the Internet via the WLAN or the PLC network. If link quality of the WLAN or the PLC network degrades, quality of the video (e.g. latency and/or delay) also degrades.

According to the present invention, the user watches the video via both the WLAN and the PLC network, and the quality of the video is not affected by the link quality of either one of the WLAN and the PLC network. Therefore, the quality of the video is improved. Besides, after the packet is transmitted successfully via one of the WLAN and the PLC network, the other one is notified to stop transmitting the same packet. Therefore, required bandwidth for improving the quality of the video is reduced.

Please note that, the first network and the second network are deployed in the same area (e.g. home or office). Either the first network or the second network can be a wireline network or a wireless network. Further, the wireline network can be a PLC network, an asymmetric digital subscriber line (ADSL) network, an Ethernet, a fiber-optic network, etc. The wireless network can be a WLAN conforming to the IEEE 802.11a/b/g standard, and is not limited herein.

Besides, the transmitter can determine whether the packet is transmitted successfully according to various criterions. For example, the transmitter can determine whether the packet is transmitted successfully according to a response corresponding to the packet transmitted by the receiver. If the transmitter receives an acknowledgement (ACK) corresponding to the packet, the transmitter determines that the packet is transmitted successfully (e.g. via the first network) and stops transmitting the same packet (e.g. via the second network). Oppositely, if the transmitter receives a negative acknowledgement (NACK) corresponding to the packet, the transmitter determines that the packet is not transmitted successfully (e.g. via the first network) and continues to transmit the same packet (e.g. via the second network). On the other hand, the network can directly determine that the packet is transmitted successfully via one of the first network and the second network, when the one of the first network and the second network is a reliable network with a low packet error rate. For example, the reliable network is the Ethernet or the fiber-optic network.

On the other hand, since the transmitter transmits the packet via the heterogeneous networks, the packet may arrive at the receiver with different delays such that the receiver can not receives the packet in sequence. Therefore, the transmitter can label the packet with a number. Accordingly, the receiver orders the packet according to the number of the packet, if the packet is not a duplicate packet. Further, if the receiver determines that the packet is the duplicate packet according to the number of the packet, the receiver deletes the packet. Besides, when the packet is transmitted successfully via the first network (or the second network), the first network (or the second network) can notify the second network (or the first network) to stop transmitting the same packet by using the number of the packet.

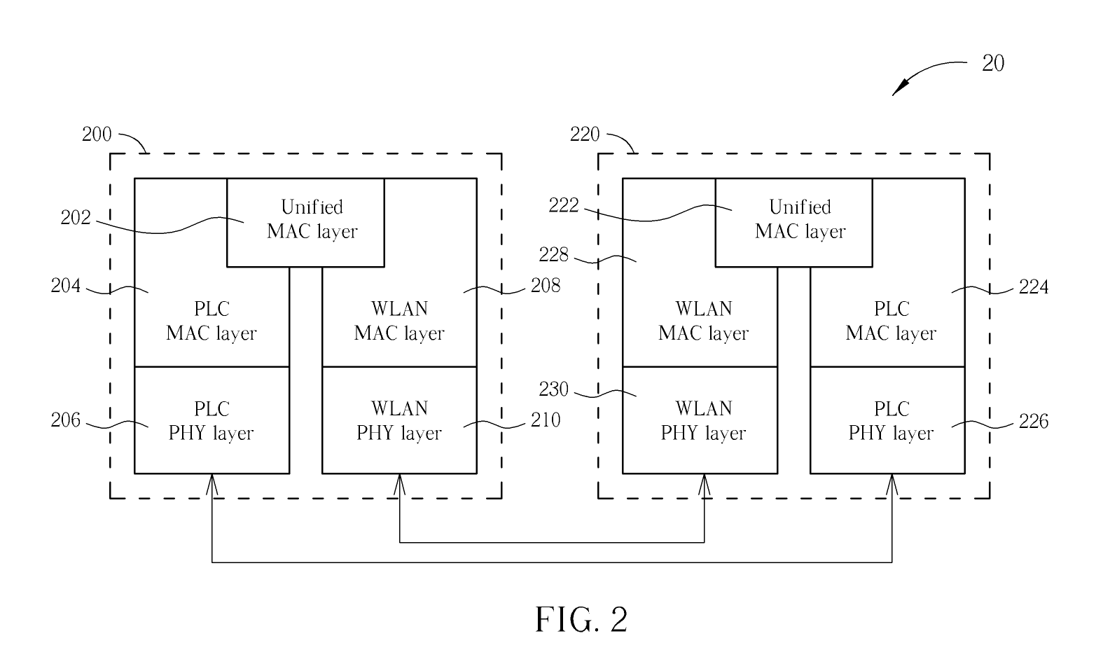

Please note that, the spirit of the above illustration and the process 10 is to transmit the same packet via heterogeneous networks, for increasing a probability that the packet is transmitted successfully, and a network via which the packet is transmitted successfully will notify the other network to stop transmitting the same packet, to reduce a bandwidth required for transmitting the packet successfully. Realization of the transmitter and the receiver is not limited as long as the abovementioned features can be realized. For example, please refer to FIG. 2, which is a schematic diagram of heterogeneous networks 20 according to an example of the present invention. The heterogeneous networks 20 are used to realized the above illustration and the process 10, and include a transmitter 200 and a receiver 220. Further, the transmitter 200 include an unified medium access control (MAC) layer 202, a PLC MAC layer 204, a PLC physical (PHY) layer 206, a WLAN MAC layer 208 and a WLAN PHY layer 210. On the other hand, the receiver 220 include an unified MAC layer 222, a PLC MAC layer 224, a PLC PHY layer 226, a WLAN MAC layer 228 and a WLAN PHY layer 230. According to the present invention, the transmitter 200 uses the unified MAC layer 202 for transmitting a packet via both a PLC network and a WLAN, and the receiver 220 uses the unified MAC layer 222 for receiving the packet via both the PLC network and the WLAN. Besides, after the packet is transmitted successfully via one of the WLAN and the PLC network, the one of the WLAN and the PLC network uses the unified MAC layer 202 for notifying the other network to stop transmitting the same packet.

In detail, when the transmitter 200 uses the unified MAC layer 202 for transmitting the packet via the PLC MAC layer 204 and the WLAN MAC layer 208, the PLC PHY layer 206 and the WLAN PHY layer 210 convert the packet into corresponding transmission signals and transmit the transmission signals via corresponding transmission links. On the other hand, the PLC PHY layer 226 and the WLAN PHY layer 230 of the receiver 220 receives the transmission signals via the corresponding transmission links, and convert the transmission signals into the packet. Then, the receiver 220 uses the unified MAC layer 222 for receiving the packet via the PLC MAC layer 224 and the WLAN MAC layer 228.

Further, if the packet is transmitted successfully via the PLC network first, e.g. the PLC MAC layer 204 receives an ACK transmitted by the PLC MAC layer 224, the PLC MAC layer 204 notifies the WLAN MAC layer 208 via the unified MAC layer 202 to stop transmitting the same packet. Oppositely, if the packet is transmitted successfully via the WLAN first, e.g. the WLAN MAC layer 208 receives the ACK transmitted by the WLAN MAC layer 228, the WLAN MAC layer 208 notifies the PLC MAC layer 204 via the unified MAC layer 202 to stop transmitting the same packet. Therefore, according to the above illustration, the present invention not only increases a probability that the packet is transmitted successfully, but also reduces a bandwidth required for transmitting the packet successfully.

To sum up, the present invention provides a method for transmitting a packet via heterogeneous networks. The method utilizes bandwidth and resource of the heterogeneous networks efficiently, for increasing robustness of the transmission, to provide improved convenience and experience to the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of transmitting a packet via heterogeneous networks, for a transmitter and a receiver using the heterogeneous networks comprising a first network and a second network, the method comprising:
the transmitter transmitting the packet to the receiver via the first network and the second network, to improve robustness of the transmission of the packet; and
the transmitter stopping transmitting the packet via the second network after the packet is transmitted successfully via the first network, or stopping transmitting the packet via the first network after the packet is transmitted successfully via the second network;
wherein the first network and the second network are of different types or with different characteristics.

2. The method of claim 1, further comprising:
the transmitter determining whether the packet is transmitted successfully according to a response corresponding to the packet, wherein the response is transmitted by the receiver.

3. The method of claim 1, wherein the first network is a wireless local area network (WLAN) or a power line communication (PLC) network, and the second network is the WLAN or the PLC network.

4. The method of claim 1, further comprising:
the transmitter determining that the packet is transmitted successfully via one of the first network and the second network, when the one of the first network and the second network is a reliable network with a low packet error rate.

5. The method of claim 4, wherein the reliable network is an Ethernet or a fiber-optic network.

6. The method of claim 1, further comprising:
the transmitter labeling the packet with a number; and
the receiver ordering the packet according to the number of the packet, or determining that the packet is a duplicate packet according to the number of the packet and deleting the packet.

7. The method of claim 1, further comprising:
the first network or the second network notifying the other network for stopping transmitting the packet by using the number of the packet.

8. The method of claim 1, wherein the transmitter uses a unified medium access control (MAC) layer, for transmitting the packet to the receiver via the first network and the second network, and the receiver uses the unified MAC layer, for receiving the packet from the transmitter via the first network and the second network.
